(19) United States
(12) Patent Application Publication
(10) Pub. No.: US 2017/0257858 A1
(43) Pub. Date: Sep. 7, 2017

(54) System and Methods for Avoiding Call Performance Degradation in a Wireless Communication Device

(71) Applicant: QUALCOMM Incorporated, San Diego, CA (US)

(72) Inventors: Manish Jain, Santa Clara, CA (US); Omesh Kumar Handa, Carlsbad, CA (US); Anoop Ramakrishna, San Diego, CA (US)

(21) Appl. No.: 15/060,720

(22) Filed: Mar. 4, 2016

(51) Int. Cl. H04W 72/04; H04L 5/00; H04L 1/18; H04L 12/26

(52) U.S. Cl. CPC H04W 72/0413; H04L 43/16; H04L 5/0055; H04L 1/1812; H04W 72/042; H04W 88/06

(57) ABSTRACT

Methods and systems improve performance of a wireless communication device supporting an active communication in a first network on a modem stack associated with a first subscriber identity module. The wireless communication device may detect that a control signal was received on the modem stack associated with the first SIM, identify a percentage of scheduled uplink feedback corresponding to the control signal received on the modem stack associated with the first SIM that will be transmitted on the first network, and determine whether determining whether the identified percentage is less than a threshold. If the identified percentage is that will be transmitted to the first network is less than the threshold, the wireless communication device may ignore operations instructed by the control signal received on the modem stack associated with the first SIM.

### BACKGROUND

Multi-subscriber identity module (SIM) wireless communication devices have become increasing popular because of their flexibility in service options and other features. One type of multi-SIM wireless communication device, a multi-SIM multi-standby (MSMS) device (e.g., a dual-SIM dual-standby (DSDS) device), enables two SIMs to be in idle mode waiting to begin communications, but only allows one SIM at a time to participate in an active communication due to sharing of a radio frequency (RF) resource (e.g., an RF transceiver). Other multi-SIM devices may extend this capability to more than two SIMs and may be configured with any number of SIMs greater than two (i.e., multi-SIM multi-standby wireless communication devices).

Wireless communication networks (referred to simply as “wireless networks”) are widely deployed to provide various communication services such as voice, packet data, broadcast, messaging, etc. Wireless networks may be capable of supporting communication for multiple users by sharing the available network resources. Such sharing of available network resources may be implemented by networks using one or more multiple-access wireless communications protocols, such as Time Division Multiple Access (TDMA), Code Division Multiple Access (CDMA), Time Division Multiple Access (TDMA), and Frequency Division Multiple Access (FDMA). These wireless networks may also utilize various radio technologies, including but not limited to Global System for Mobile Communications (GSM), Universal Mobile Telecommunications System (UMTS), High Speed Packet Access (HSPA) is CDMA2000, Advanced Mobile Phone Service (AMPS), General Packet Radio Services (GPRS), Long Term Evolution (LTE), High Data Rate (HDR) technology (e.g., 1×EV technology), etc.

An MSMS wireless communication device typically shares a RF resource among two or more subscriptions, actively communicating for a single SIM or subscription with an associated network at a given time. Therefore, during an active data communication on one SIM (e.g., the first SIM), the wireless communication device periodically tunes the shared RF resource away from a first wireless network associated with a first MI to another wireless network associated with another SIM (e.g., the second SIM) to monitor signals or acquire a connection. As a result, depending on the duration of the tune away, the network supported by the first SIM may successfully transmit control signals to the wireless communication device, but fail to receive corresponding feedback (e.g., acknowledgement messages) regarding whether such signals were decoded by the MSMS wireless communication device. Such failure to receive an acknowledgement may cause a mismatch in physical layer configurations between the wireless communication device and the network. While the mismatch may be addressed by performing a cell update or radio link control reset, such procedures involve an inefficient use of power and/or network resources, as well as degrade performance for the active communication.

### SUMMARY

Methods and devices implementing methods of various examples may enable improving performance of wireless communication device configured by detecting an active communication with a first network on a modem stack associated with a first subscriber identity module (SIM), detecting that a control signal was received on the modem stack associated with the first MI, identifying a percentage of scheduled uplink feedback corresponding to the control signal received on the modem stack associated with the first SIM that will be transmitted on the first network (“identified percentage”), determining whether the identified percentage is less than a threshold, and ignoring operations instructed by the control signal received on the modem stack associated with the first SIM in response to determining that the percentage of scheduled uplink feedback that will be transmitted on the first network is less than the threshold.

In some examples, identifying the percentage of scheduled uplink feedback that will be transmitted on the first network may include calculating an amount of overlap between a slot scheduled to carry physical layer acknowledgment/non-acknowledgment (ACK/NACK) data and an upcoming signal disruption period. In some examples, the threshold may be based on a configuration associated with the first network. In some examples, calculating the amount of overlap may include using offsets between subframes on physical channels to identify a transmission time interval (TTI) for uplink feedback corresponding to the control signal received on the modem stack associated with the first SIM, and identifying scheduled timing for an upcoming signal disruption period.

In some examples, ignoring an instruction of the control signal received on the modem stack associated with the first SIM may include maintaining a current physical layer configuration on the modem stack associated with the first SIM, and replacing scheduled uplink feedback with blank data using a silence descriptor frame. In some examples, the control signal received on the modem stack associated with the first SIM may include an instruction to transition to a dual carrier mode for high speed downlink packet access (HSDPA) or high speed uplink packet access (HSUPA) communications by enabling a secondary carrier. In some examples, the control signal received on the modem stack associated with the first SIM may include an instruction to transition to a single carrier mode for high speed downlink packet access (HSDPA) or high speed uplink packet access (HSUPA) communications by disabling a secondary carrier.

In some examples, the control signal received on the modem stack associated with the first SIM may include one or more instructions carried on a high speed signaling control channel (HS-SCCH). In some examples, the control signal received on the modem stack associated with the first SIM may include an instruction to activate or deactivate one or more Continuous Packet Connectivity (CPC) feature. In some examples, the ACK/NACK data may be used in a hybrid automatic repeat request (HARQ) protocol, and the ACK/NACK data may indicate whether the control signal received on the modem stack associated with the first SIM was successfully decoded on the modem stack associated with the first SIM.

In some examples, the slot scheduled to carry the ACK/NACK data corresponding to the control signal received on the modem stack associated with the first SIM may include a first slot of a high speed dedicated physical control channel (HS-DPCCH) subframe. In some examples, a start of the HS-DPCCH subframe may be aligned to provide 7.5 slots of processing time from an end of a high speed physical downlink shared channel (HS-PDSCH) subframe carrying downlink data. In some examples, ignoring operations instructed by the control signal received on the modem stack associated with the first SIM may include replacing scheduled uplink feedback corresponding to the control signal received on the modem stack associated with the first SIM with blank data using a silence descriptor frame.

Some example methods may further include detecting an upcoming signal disruption period during the active communication in the first network by detecting a scheduled tune-away by a shared radio frequency (RF) resource from the first network to a second network associated with a second SIM. In some examples, the shared RF resource may tune back to the first network after the tune-away. Some example methods may further include detecting an upcoming signal disruption period during the active communication in the first network by detecting a temporary deep fade on a channel associated with connecting to the first network.

Some example methods may further include detecting an upcoming signal disruption period during the active communication in the first network by detecting a gap in the active communication to perform neighbor cell measurements. In some examples, the first network may support at least high speed downlink packet access (HSDPA).

Further examples include wireless communication devices having a processor configured with processor-executable instructions to perform operations of the example methods summarized above. Further examples include wireless communication devices having means for performing functions of the example methods summarized above. Further examples include non-transitory processor-readable storage media storing processor-executable instructions configured to cause a processor or a wireless communication device to perform operations of the example methods summarized above.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a communication system block diagram of a network suitable for use with various examples.

FIG. 2 is a block diagram illustrating a wireless communications device according to various examples.

FIG. 3 is a system architecture diagram illustrating example protocol layer stacks implemented by the wireless communication device of FIG. 2.

FIG. 4 is a process flow diagram illustrating an example method for managing physical layer configurations on a wireless communication device.

FIG. 5 is a component diagram of an example wireless communication device suitable for use with various examples.

FIG. 6 is a component diagram of another example wireless communication device suitable for use with various examples.

### DETAILED DESCRIPTION

Various examples will be described in detail with reference to the accompanying drawings. Wherever possible the same reference numbers will be used throughout the drawings to refer to the same or like parts. References made to particular examples and implementations are for illustrative purposes, and are not intended to limit the scope of the claims.

Various examples provide methods, systems, and devices that improve performance on a wireless communication device configured to communicate on multiple subscriber identity modules (SIMs) using a shared radio frequency (RF) resource. In particular, the various examples may avoid call performance degradation on a first SIM by preventing acting on downlink control signals when corresponding uplink feedback, such as acknowledgement/non-acknowledgment (ACK/NACK) messages, will not be transmitted or properly decoded by the network. For example, a tune-away to a network associated with another SIM, or a temporary deep fade on a channel associated with the first network, may overlap with the uplink transmission. Due to such overlap, only a portion of the feedback data scheduled to be sent to the network will be transmitted (e.g., in the case of a tune away) or received (e.g., in the case of a deep fade) by the network, which may be insufficient to enable the network to extract the information.

In some examples, at least one SIM of the MSMS wireless communication device may be associated with High Speed Packet Access (HSPA) technology. Specifically, the at least one SIM may have dual carrier capability to support multiple modes for High Speed Downlink Packet Access (HSDPA) and/or High Speed Uplink Packet Access (HSUPA). Such dual carrier capability enables switching between a (normal) single carrier mode using a primary cell, and a dual carrier mode that uses both a primary and a secondary cell. In some examples, the dual carrier capability may be limited to downlink communications (i.e., HSDPA), while in some examples dual carrier capability may also be enabled for uplink communications (HSUPA).

In various HSPA systems, the network controls transitions between the single carrier mode and dual carrier mode through enabling/disabling the secondary carrier. In some systems, the wireless communication device receives instructions on a high speed shared control channel (HS-SCCH) to activate and/or deactivate a secondary carrier. During a tune-away from an active communication on an HSPA-enabled SIM, control signaling from the network indicating a downlink mode transition may be missed. As a result, the wireless communication device and the network may become mismatched with respect to physical layer configurations. The network may cease scheduling downlink data for the wireless communication device, prompting a cell update on the HSPA-enabled SIM in order to re-synchronized with the network.

Various examples enable a MSMS wireless communication device to maintain synchronization of physical layer configurations when a signal disruption event is scheduled or anticipated. Such synchronization may involve using existing channel structures to determine whether feedback for a control signal will be missed, and if so to preempt use of that control signal on the device.

The term “wireless communication device” is used herein to refer to any one or all of cellular telephones, smart phones, personal or mobile multi-media players, personal data assistants (PDAs), laptop computers, tablet computers, smart books, palm-top computers, wireless electronic mail receivers, multimedia Internet enabled cellular telephones, wireless gaming controllers, and similar personal electronic devices that include a programmable processor and memory and circuitry for establishing wireless communication pathways and transmitting/receiving data via wireless communication pathways.

As used herein, the terms “subscription,” “SIM,” “SIM card,” and “subscriber identification module” are used interchangeably to mean a memory that may be an integrated circuit or embedded into a removable card, which stores an International Mobile Subscriber Identity (IMSI), related key, and/or other information used to identify and/or authenticate a wireless communication device on a network. Examples of SIMs include the Universal Subscriber Identity Module (USIM) provided for in the LTE 3GPP standard, and the Removable User Identity Module (R-UIM) provided for in the 3GPP2 standard. Universal Integrated Circuit Card (UICC) is another term for SIM.

The terms subscription and SIM may also be used as shorthand reference to a communication network associated with a particular SIM, since the information stored in a SIM enables the wireless communication device to establish a communication link with a particular network, thus the SIM and the communication network, as well as the services and subscriptions supported by that network, correlate to one another.

As used herein, the terms “multi-SIM wireless communication device,” “multi-SIM wireless communication device,” “dual-SIM wireless communication device,” “dual-SIM dual-standby device,” and “DSDS device” are used interchangeably to describe a wireless communication device that is configured with more than one SIM and allows idle-mode operations to be performed on two networks simultaneously, as well as selective communication on one network while performing idle-mode operations on the other network.

As used herein, the terms “power-saving mode,” “power-saving-mode cycle,” “discontinuous reception,” and “DRX cycle” are used interchangeably to refer to an idle-mode process that involves alternating sleep periods (during which power consumption is minimized) and awake (or “wake-up”) periods (in which normal power consumption and reception are returned and the wireless communication device monitors a channel by normal reception). The length of a power-saving-mode cycle, measured as the interval between the start of a wake-up period and the start of the next wake-up period, is typically signaled by the network.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UNITS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

In some wireless networks, a wireless communication device may have multiple subscriptions to one or more networks (e.g., by employing multiple subscriber identity module (SIM) cards or otherwise). Such a wireless communication device may include, but is not limited to, a dual-SIM dual-standby (DSDS) device. For example, a first subscription may be a first technology standard, such as Wideband Code Division Multiple Access (WCDMA), while a second subscription may support the same technology standard or a second technology standard, such as Global System for Mobile Communications (GSM) Enhanced Data rates for GSM Evolution (EDGE) (also referred to as GERAN).

A multi-SIM wireless communication device that supports two or more SIM cards may have a number of capabilities that provide convenience to a user, such as allowing different wireless carriers, plans, telephone numbers, billing accounts, etc. on one device. Developments in multi-SIM wireless communication device technology have led to a variety of different options for such devices. For example, an “active dual-SIM” wireless communication device allows two SIMs to remain active and accessible to the device. In particular, a type of active dual-SIM wireless communication device may be a “dual-active dual standby” (DSDS) wireless communication device in which two SIMs are configured to share a single transceiver (i.e., RF resource).

High Speed Downlink Packet Access (HSDPA) and High Speed Uplink Packet Access (HSUPA) optimize UMTS for packet data services in downlink and uplink, respectively. Together, HSDPA and HSUPA technologies are referred to as High Speed Packet Access (HSPA). Details of HSDPA are provided in 3GPP Release 5, and features of HSUPA are provided in 3GPP Release 6. Within 3GPP Release 7, 8, 9 and 10, further improvements to HSPA have been specified in the context of HSPA+ or HSPA evolution. Based on the asymmetrical usage of bandwidth in downlink services, network operators typically will deploy HSDPA before HSUPA. However, the terms “HSDPA” and “HSPA” may be used interchangeably to refer to either or both of HSDPA and HSUPA features in UMTS.

In an active communication on a wireless communication device using HSPA, data may be exchanged between the wireless communication device (or modem stack associated with a SIM of the wireless communication device) based on a timing pattern for radio frames that have a duration of 10 ms. Data transmitted in a radio frame may be referred to as a transport block. Depending on the coding and modulation scheme employed, a transport block may include from as few as 137 bits to as many as 27,952 bits. The 10 ms radio frame may be partitioned into five subframes, each of which has a duration of 2 ms and includes three slots (0.667 ms each). A transmission time interval (TTI) in HSPA is equal to one subframe, which is the smallest unit of time in which a wireless communication device may be scheduled and served.

Typically, downlink data packets may be transmitted in the High-Speed Downlink Shared Channel (HS-DSCH), which is a transport channel that carries data for one or more devices in each TTI. The sharing of the HS-DSCH may be dynamic, changing from TTI to TTI. The number of code channels that map onto a single HS-DSCH may vary dynamically between 1 and 15.

A number of physical channels are also deployed for communications in HSPA. For example, the High Speed Physical Downlink Channel (HS-PDSCH) carries downlink data sent on the HS-DSCH for different various devices. The downlink High Speed Shared Control Channel for HS-DSCH (HS-SCCH) carries signaling for the HS-PDSCH that may be sent by the network in the same radio frame. In WCDMA, HS-SCCH orders are sent by the network to provide instructions that control various physical layer configurations, including activation/deactivation of DC-HSDPA, DC-HSUPA, Continuous Packet Connectivity (CPC)-Discontinuous Reception (DRX), CPC-Discontinuous Transmission (DTX), etc. The first of the three slots within the 2-ms subframe for the HS-SCCH carries information for HS-PDSCH reception, such as the channelization code set and the modulation scheme. After receiving the first slot in the HS-SCCH subframe, the wireless communication device may decode the received information and prepare to receive the HS-PDSCH.

The High Speed Dedicated Physical Control Channel for HS-DSCH (HS-DPCCH) carries control information to the network, such as feedback reporting the status of various downlink transmissions. For example, the HS-DPCCH carries hybrid automatic repeat request (HARQ) feedback (e.g., acknowledgment/non-acknowledgment (ACK/NACK) for retransmission decisions) related to a downlink HS-DSCH. Similar to the downlink physical channels, the HS-DPCCH is sent in a 2-ms subframe, which has three slots. In some systems, the HARQ-ACK/NACK is carried in the first slot of the HS-DPCCH subframe, and one or more channel quality indicators (CQI) in the second and third slots. When the network sends an HS-SCCH order to the wireless communication device, the wireless communication device responds by sending ACK/NACK data on the HS-DPCCH. Thus, sending an acknowledgement (ACK) message in response to an HS-SCCH order is helpful for these physical layer configurations, as mismatches in configuration between a wireless communication device and the network can negatively impact communications.

In a system that employs HSDPA, wireless communication devices may be capable of both single carrier HSDPA communications and dual carrier HSDPA communications. In a single carrier mode, a wireless communication device (or modem stack associated with a SIM of the wireless communication device) communicates with the network through signaling provided by a single serving cell (i.e., a primary carrier). The wireless communication device may switch between single carrier and dual carrier modes by responding to network signals that enable and disable a secondary carrier in the downlink.

In a dual carrier mode, the wireless communication device (or modem stack associated with a SIM of the wireless communication device) receives downlink signaling from two cells that transmit on separate, adjacent carriers with potentially different cell powers. The primary and secondary carriers (i.e., serving cell and secondary cell, respectively) may transmit data to the wireless communication device simultaneously on the HS-PDSCH and HS-SCCH, with each HS-PDSCH carrying independent data. The wireless communication device typically determines the configuration of the HS-PDSCH for the carrier(s) by reading the HS-SCCH for each carrier. Various instructions relating to dual carrier HSDPA are also communicated to the wireless communication device on the HS-SCCH, such as control signals to activate or deactivate a secondary carrier.

Following receiving information on the HS-SCCH, the wireless communication device may transmit feedback (e.g., an acknowledgment or non-acknowledgment (ACK/NACK) data) on the HS-DPCCH to inform the network whether the instruction or other information on the HS-SCCH was successfully decoded. For multi-SIM scenarios involving single receiver-DSDS (SR-DSDS) or dual receiver-DSDS (DR-DSDS), the wireless communication device may need to tunes to other networks to allow for processing associated with different SIMs. If the subframe on HS-DPCCH on uplink overlaps with a transmission gap, such as caused by a tune away during multi-SIM operations or a compressed mode (CM) gap to perform neighbor cell measurements, the wireless communication device will not be able to transmit a corresponding ACK for a successful HS-SCCH order. Since the network does not receive the ACK, the network will not perform the operations associated with the HS-SCCH order. Thus, a signal disruption event, such as a tune away from the active communication on the HSPA-enabled SIM, may impact some or all of any downlink data being received or uplink data being transmitted. In some examples, the duration of a tune-away period may range from few to 100 ms depending on the radio access technology of the network to which the RF resource is tuned. As such, data scheduled for subsequent transmission on the HSPA-enabled SIM can be affected. For example, if the tune-away period begins during a HS-DPCCH subframe, transmission of some or all of HARQ feedback for a received HS-SCCH instruction may fail. Any portion of the HS-DPCCH subframe that does not overlap with the tune-away period is typically still transmitted to the network, which may include at least a portion of the ACK/NACK data. However, the portion of the ACK/NACK data may be too small to enable the network to decode the HARQ feedback.

When expected HARQ feedback for control signals relating to physical layer configurations is either not received or not decoded by the network, no changes or transitions are made on the network side. However, a wireless communication device may start processing the HS-SCCH order and change its operation as per the HS-SCCH order type and purpose. This mismatch in configuration at the physical layer between the wireless communication device and the network may waste some resources and may result in radio link control (RLC) resets or call drops. Thus, assuming the control signals were successfully received by the wireless communication device, a disparity may develop between the physical layer configurations associated with the HSPA-enabled SIM and corresponding configurations on the network. That is, if the wireless communication device successfully decoded the HS-SCCH instruction and makes configuration changes, the wireless communication device may become out-of-sync with respect to the physical layer configurations of the network.

For example, when HS-SCCH control signals instruct enabling or disabling a dual carrier mode for HSDPA, the network may fail to receive some of the uplink user data and/or control information due to the differences in encoding for the HS-DPCCH depending on whether a secondary carrier is enabled. In another example, when HS-SCCH control signals instruct enabling or disabling dual carrier mode for HSUPA, the network may fail to receive some of the uplink user data and/or control information due to the network incorrectly monitoring the HS-DPCCH relative to the number of carriers on which uplink data is being scheduled.

Once the physical layer configurations of a wireless communication device are out-of-sync with the corresponding network configurations, the first network may stop scheduling downlink user data and downlink feedback for uplink data. The network may perform a radio link control (RLC) reset on the network in order to re-synchronize physical layer operations between the network and the wireless communication device. For example, if the network sends an HS-SCCH order to activate a secondary uplink carrier and if an ACK is missed on the uplink due to a transmission gap, then the wireless communication device would enable the dual carrier mode for HSUPA and transmit enhanced uplink (EUL) data on secondary carrier, as defined in 3GPP specifications. Since the network would not be monitoring the secondary carrier because of not receiving the ACK on the HS-DPCCH, the EUL data would never reach the network and thus would cause an RLC reset on the wireless communication device.

For clarity, while the techniques and examples described herein relate to a wireless communication device configured with at least one WCDMA/UMTS SIM and/or GSM SIM, the example techniques may be extended to subscriptions on other radio access networks (e.g., 1×RTT/CDMA2000, EVDO, LTE, WiMAX, Wi-Fi, etc.). In that regard, the messages, physical and transport channels, radio control states, etc. referred to herein may also be known by other terms in various radio access technologies and standards. Further, the messages, channels and control states may be associated with different timing in other radio access technologies and standards.

In various examples, an RF resource of a DSDS device may be configured to be shared between a plurality of SIMs, but may be employed by default to perform communications on a network enabled by a first SIM, such as a network capable of high-speed data communications (e.g., WCDMA, HSDPA, LTE, etc.). As such, a modem stack associated with a second SIM of the device may often be in idle mode with respect to a second network. Depending on the radio access technology of the second network, such idle mode states may involve implementing a power saving mode that includes a cycle of sleep and awake states. For example, if the second network is a GSM network, during idle mode the modem stack associated with the second SIM may implement discontinuous reception (DRX). In DRX, the wireless communication device may save power by not monitoring the HS-PDSCH in a given subframe.

Specifically, during a wake-up period (i.e., awake state), the timing of which may be set by the second network for a paging group to which the second SIM belongs. The modem stack associated with the second SIM may attempt to use the shared RF resource to monitor a paging channel of the second network for paging requests. During the sleep state, the modem stack may power off most processes and components, including the associated RF resource.

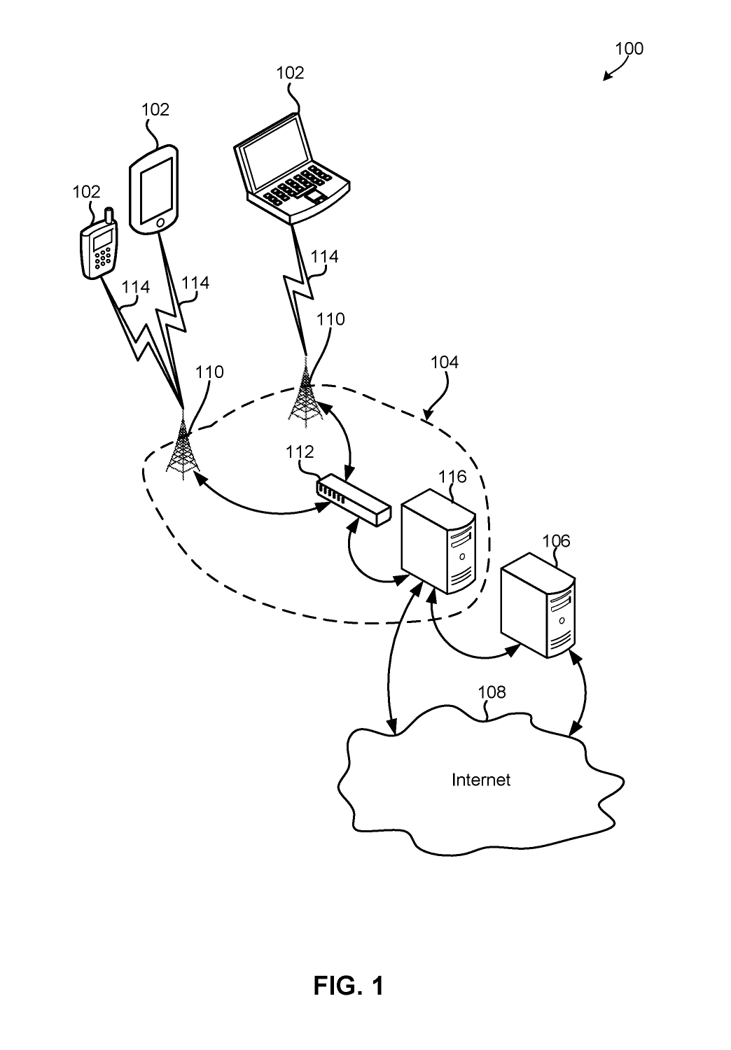

Various examples may be implemented within a variety of communication systems, such as the example communication system 100 illustrated in FIG. 1. The communication system 100 may include one or more wireless communication devices 102, a telephone network 104, and network servers 106 coupled to the telephone network 104 and to the Internet 108. In some examples, the network server 106 may be implemented as a server within the network infrastructure of the telephone network 104.

A typical telephone network 104 includes a plurality of cell base stations 110 coupled to a network operations center 112, which operates to connect voice and data calls between the wireless communication devices 102 (e.g., tablets, laptops, cellular phones, etc.) and other network destinations, such as via telephone land lines (e.g., a plain old telephone system (POTS) network, not shown) and the Internet 108. The telephone network 104 may also include one or more servers 116 coupled to or within the network operations center 112 that provide a connection to the Internet 108 and/or to the network servers 106. Communications between the wireless communication devices 102 and the telephone network 104 may be accomplished via two-way wireless communication links 114, such as GSM, UMTS, EDGE, 4G, 3G, CDMA, TDMA, LTE, and/or other communication technologies.

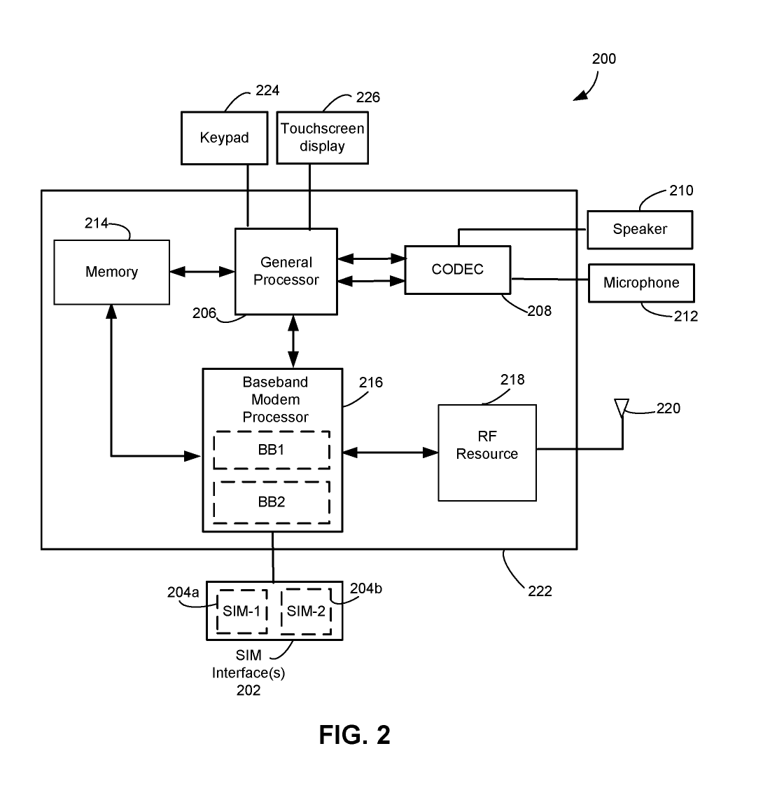

FIG. 2 is a functional block diagram of an example wireless communication device 200 that is suitable for implementing various examples. The example wireless communication device 200 may be similar to one or more of the wireless communication devices 102 described with reference to FIG. 1. With reference to FIGS. 1-2, the wireless communication device 200 may be a single-SIM device, or a multi-SIM device, such as a dual-SIM device. In an example, the wireless communication device 200 may be a dual-SIM dual-standby (DSDS) device. The wireless communication device 200 may include at least one SIM interface 202, which may receive a first SIM (SIM-1) 204a that is associated with a first subscription. In some examples, the at least one SIM interface 202 may be implemented as multiple SIM interfaces 202, which may receive at least a second SIM (SIM-2) 204b that is associated with at least a second subscription.

A SIM in various examples may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM 204a, 204b may have a CPU, ROM, RAM, EEPROM and I/O circuits. One or more of the first SIM 204a and second SIM 204b used in various examples may contain user account information, an IMSI a set of SIM application toolkit (SAT) commands and storage space for phone book contacts. One or more of the first SIM 204a and second SIM 204b may further store home identifiers (e.g., a System Identification Number (SID)/Network Identification Number (NID) pair, a Home PLMN (HPLMN) code, etc.) to indicate the SIM network operator provider. An Integrated Circuit Card Identity (ICCID) SIM serial number may be printed on one or more SIM 204 for identification.

The wireless communication device 200 may include at least one controller, such as a general-purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory tangible computer readable storage medium that stores processor-executable instructions. For example, the instructions may include routing communication data relating to a subscription though a corresponding baseband-RF resource chain. The memory 214 may store operating system (OS), as well as user application software and executable instructions.

The general purpose processor 206 and memory 214 may each be coupled to at least one baseband-modem processor 216. Each SIM 204a, 204b in the wireless communication device 200 may be associated with a baseband-RF resource chain that includes at least one baseband-modem processor 216 and at least one RF resource 218. In some examples, the wireless communication device 200 may be a DSDS device, with both SIMs 204a, 204b sharing a single baseband-RF resource chain that includes the baseband-modem processor 216 and RF resource 218. In some examples, the shared baseband-RF resource chain may include, for each of the first SIM 204a and the second SIM 204b, separate baseband-modem processor 216 functionality (e.g., BB1 and BB2). The RF resource 218 may be coupled to at least one antenna 220, and may perform transmit/receive functions for the wireless services associated with each SIM 204a, 204b of the wireless communication device 200. The RF resource 218 may implement separate transmit and receive functionalities, or may include a transceiver that combines transmitter and receiver functions.

In some examples, the general purpose processor 206, memory 214, baseband-modem processor 216, and RF resource 218 may be included in a system-on-chip device 222. The first and second SIMs 204a, 204b and their corresponding interface(s) 202 may be external to the system-on-chip device 222. Further, various input and output devices may be coupled to components of the system-on-chip device 222, such as interfaces or controllers. Example user input components suitable for use in the wireless communication device 200 may include, but are not limited to, a keypad 224 and a touchscreen display 226.

In some examples, the keypad 224, touchscreen display 226, microphone 212, or a combination thereof, may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or to receive a telephone number. As another example, the request to initiate the outgoing call may be in the form of a voice command received via the microphone 212. Interfaces may be provided between the various software and functions in the wireless communication device 200 to enable communication between them, as is known in the art.

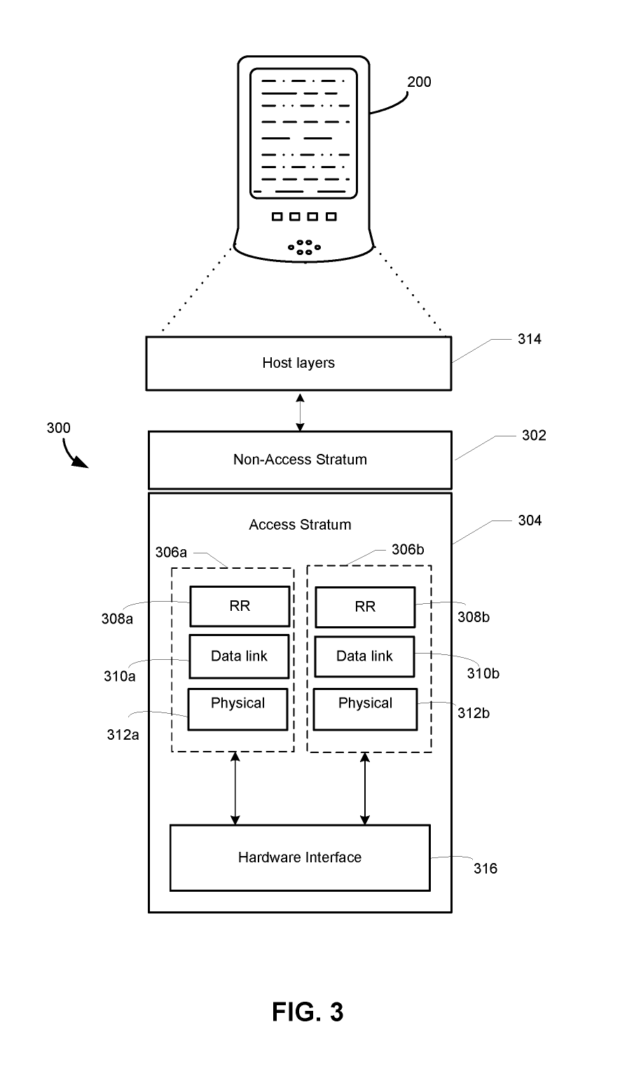

Referring to FIG. 3, wireless communication device 200 may have a layered software architecture 300 to communicate over access networks associated with SIMs. The software architecture 300 may be distributed among one or more processors, such as baseband-modem processor 216. The software architecture 300 may also include a Non Access Stratum (NAS) 302 and an Access Stratum (AS) 304. The NAS 302 may include functions and protocols to support traffic and signaling between SIMs of the wireless communication device 200 (e.g., first SIM/SIM-1 204a, second SIM/SIM-2 204b) and their respective core networks. The AS 304 may include functions and protocols that support communication between the SIMs (e.g., first SIM 204a, second SIM 204b) and entities of their respective access networks (such as a mobile switching center (MSC) if in a GSM network).

In the multi-SIM wireless communication device 200, the AS 304 may include multiple protocol stacks, each of which may be associated with a different SIM. For example, the AS 304 may include protocol stacks 306a, 306b, associated with the first and second SIMs 204a, 204b, respectively. Although described below with reference to GSM-type communication layers, protocol stacks 306a, 306b may support any of variety of standards and protocols for wireless communications.

Each protocol stack 306a, 306b may respectively include Radio Resource management (RR) layers 308a, 308b. The RR layers 308a, 308b may be part of Layer 3 of a GSM signaling protocol, and may oversee the establishment of a link between the wireless communication device 200 and associated access networks. In the various examples, the NAS 302 and RR layers 308a, 308b may perform the various functions to search for wireless networks and to establish, maintain and terminate calls.

In some examples, each RR layer 308a, 308b may be one of a number of sub-layers of Layer 3. Other sub-layers may include, for example, connection management (CM) sub-layers (not shown) that route calls, select a service type, prioritize data, perform QoS functions, etc.

Residing below the RR layers 308a, 308b, the protocol stacks 306a, 306b may also include data link layers 310a, 310b, which may be part of Layer 2 in a GSM signaling protocol. The data link layers 310a, 310b may provide functions to handle incoming and outgoing data across the network, such as dividing output data into data frames and analyzing incoming data to ensure the data has been successfully received. In some examples, each data link layer 310a, 310b may contain various sub-layers (e.g., media access control (MAC) and logical link control (LLC) layers (not shown)). Residing below the data link layers 310a, 310b, the protocol stacks 306a, 306b may also include physical layers 312a, 312b, which may establish connections over the air interface and manage network resources for the wireless communication device 200.

While the protocol stacks 306a, 306b provide functions to transmit data through physical media, the software architecture 300 may further include at least one host layer 314 to provide data transfer services to various applications in the wireless communication device 200. In some examples, application-specific functions provided by the at least one host layer 314 may provide an interface between the protocol stacks 306a, 306b and the general processor 206. In alternative examples, the protocol stacks 306a, 306b may each include one or more higher logical layers (e.g., transport, session, presentation, application, etc.) that provide host layer functions. In some examples, the software architecture 300 may further include in the AS 304 a hardware interface 316 between the physical layers 312a, 312b and the communication hardware (e.g., one or more RF resource).

In various examples, the protocol stacks 306a, 306b of the layered software architecture may be implemented to allow modem operation using information provisioned on multiple SIMs. Therefore, a protocol stack that may be executed by a baseband-modem processor is interchangeably referred to herein as a modem stack.

Although described below with reference to UNITS-type and GSM-type communication layers, the modem stacks in various examples may support any of a variety of current and/or future protocols for wireless communications. For examples, the modem stacks in various examples may support networks using other radio access technologies described in 3GPP standards (e.g., Long Term Evolution (LTE), etc.), 3GPP2 standards (e.g., 1×RTT/CDMA2000, Evolved Data Optimized (EVDO), Ultra Mobile Broadband (UMB), etc.) and/or Institute of Electrical and Electronics Engineers (IEEE) standards Worldwide Interoperability for Microwave Access (WiMAX), Wi-Fi, etc.).

As described, a timing conflict may be caused by a signal disruption period during an active communication on a first SIM using HSDPA. As described, radio frames on each timeline have a duration of 10 ms, with five 2 ms subframes (i.e., TTIs) that are each made up of three slots.

In various examples, control signals for scheduled devices may be transmitted on the HS-SCCH, which is aligned to the radio frame boundary. The HS-SCCH signaling may identify the scheduled devices, as well as the transport format used for each scheduled device. Downlink data may be transmitted on the HS-PDSCH, starting two slots after the beginning of the HS-SCCH subframe. In various examples, the HS-DPCCH subframe starts around 7.5 slots from the end of the transmission on the HS-PDSCH.

A wireless communication device may process the HS-SCCH to determine whether signaling indicates that a transmission is scheduled. If scheduled, the wireless communication device may further process the HS-PDSCH to recover the data. The wireless communication device may transmit on the HS-DPCCH uplink feedback data corresponding to the control signals on the HS-SCCH and the data transmission on the HS-PDSCH to the network.

Further, the HS-DPCCH transmitted by the wireless communication device may include HARQ feedback in the first slot, as well as CQI in the second and third slots to assist the network with data transmission on the downlink. For example, the modem stack of the first SIM may send an ACK on the HS-DPCCH for packets decoded correctly, and send a non-acknowledgement (NACK) message for packets erroneously decoded.

A signal disruption, such as tuning the RF resource to a network associated with another SIM, may overlap with some of the HSDPA uplink and/or downlink transmissions. In particular, a signal disruption period may overlap with some or all of a HS-DPCCH subframe carrying HARQ feedback (i.e., the first slot of the HS-DPCCH subframe).

Since devices in the same cell or cells may share the HS-PDSCH, the HS-SCCH may be used to indicate which device should read which HS-PDSCH during a particular subframe. At the time of call establishment, each wireless communication device may be assigned a unique identifier and one or more HS-SCCH to monitor. When the network intends to transmit downlink data to the wireless communication device, the network will indicate on the HS-SCCH(s) the device's identity and the information for the device to be able to decode the HS-PDSCH (for example, number of HS-PDSCHs, their channelization codes, the HARQ process number, etc.).

The wireless communication device may process the HS-SCCH in each subframe to determine whether signaling has been sent indicating upcoming transmission to that device. If the wireless communication device is scheduled in a given subframe, then the wireless communication device may obtain the transport format from the signaling and process the HS-PDSCH based on the transport format to recover the packet sent to the wireless communication device. The wireless communication device may then send either an ACK if the packet is decoded correctly or a NACK otherwise.

In some examples, the modem stack associated with the first SIM may send a CQI on the HS-DPCCH in each subframe. If the network schedules sending data to the first SIM, the network may use the most recent CQI to determine an appropriate transport format and transmit power for data transmission to the wireless communication device. The transport format may indicate the modulation scheme, transport block size, and channelization code set to use for data transmission to the wireless communication device.

As discussed, in a DSDS device in which the SIMs are configured to implement discontinuous reception (DRX), the RF resource is typically used to support both SIMs when both are in idle mode, but one SIM at a time when at least one SIM transitions out of idle mode. Conventionally, the DSDS device will still monitor system information from, and maintain a connection with, the serving network of the second SIM. That is, the RF resource periodically tunes away from communication on the first SIM in order to decode a paging channel associated with the second SIM.

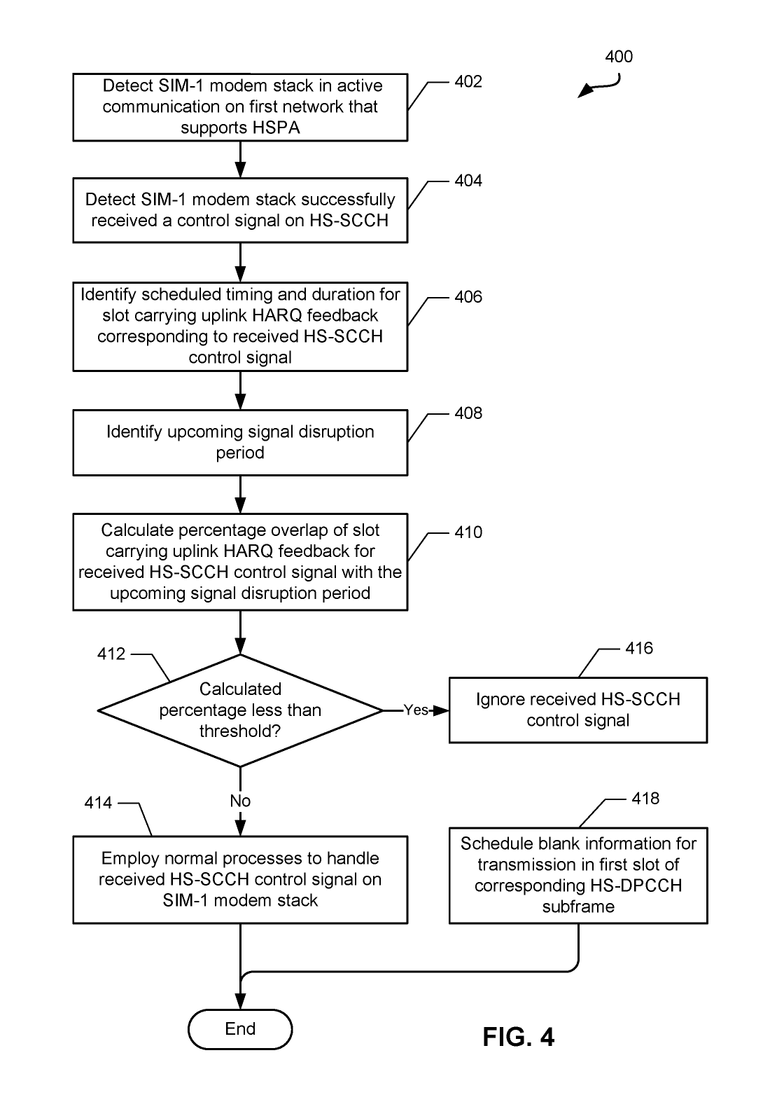

FIG. 4 illustrates an example method 400 for managing synchronization between physical layer configurations associated with a first SIM on a wireless communication device, and corresponding physical layer configurations represented in a network. Specifically, such management may maintain an existing communication on the first SIM by avoiding a radio link control (RLC) reset upon signal disruption (e.g., a tune-away to a network associated with another SIM).

With reference to FIGS. 1-4, the wireless communication device may be a single-SIM or multi-SIM wireless communication device that is configured with a single shared RF resource (e.g., 218). In various examples, the operations of the method 400 may be implemented by one or more processors of the wireless communication device, such as a general purpose processor (e.g., 206) and/or baseband-modem processor (e.g., 216), or a separate controller (not shown) that may be coupled to memory (e.g., 214) and to a baseband-modem processor.

In block 402, the wireless communication device processor may detect that a modem stack associated with a first SIM (“SIM-1”) is participating in an active communication on a first network that supports HSPA (e.g., HSDPA and/or HSUPA). In block 404, the processor may detect that the modem stack associated with the first SIM has successfully received a control signal on the HS-SCCH in the active communication on the first network. In some examples, such control signal may carry the wireless communication device/modem stack identity, channel parameters of the associated HS-PDSCH, and/or instructions for changing to a new operation/carrier mode.

In block 406, the processor may identify the scheduled timing and duration for a slot carrying uplink HARQ feedback corresponding to the received HS-SCCH control signal. As described, such identification may be based on the known timing offsets between TTIs for the various physical channels, as well as subframe and slot durations. Specifically, the start of the HS-PDSCH corresponding to the received HS-SCCH may be offset by two slots from the beginning of the HS-SCCH. The start of the corresponding HS-DPCCH transmission will be offset by 7.5 slots from the end of the HS-PDSCH. The HS-DPCCH ACK/NACK is transmitted deterministically 7.5 slots after receiving the HS-SCCH. As described, each slot has a duration of 0.667 seconds, and the ACK/NACK data is carried in the first slot of the HS-DPCCH. Therefore, based on the known timing of the received HS-SCCH, both the expected start time and duration of the slot carrying the HARQ feedback (i.e., ACK/NACK information) may be identified.

In block 408, the processor may identity an upcoming signal disruption period. In some examples, the wireless communication device may be a multi-SIM wireless communication device operating in a MSMS mode, and the signal disruption period may be a tune-away gap for a second network supported by a second SIM. That is, in some examples the tune-away gap may be a short period in which the shared RF resource (e.g., 218) tunes away from the first network to the second network, and subsequently tunes back to the first network. In some examples, the modem stack associated with the second SIM may be camped in idle mode on the second network supported by the second SIM. As described, the tune-away to the second network may be used to monitor a paging channel in a timeslot assigned to a paging group of the second SIM, and may be performed periodically according to a DRX cycle established by the second network.

Whenever the wireless communication device receives an HS-SCCH order, the wireless communication device processor may check the percentage of the HS-DPCCH ACK/NACK slot corresponding to the order that will be actually transmitted by executing block 410. In block 410, the wireless communication device processor may calculate the percentage of the slot carrying the HARQ feedback for the received HS-SCCH control signal that will overlap with the upcoming signal disruption period. In some examples, the percentage may be zero, such as when the upcoming signal disruption period is scheduled to start after the expected transmission of the first slot of the HS-DPCCH subframe. In some examples, the percentage may be greater than zero, such as when the upcoming signal disruption period is scheduled to start and/or end during the expected transmission of the first slot in the HS-DPCCH subframe. In some examples, the percentage may be 100, such as when the upcoming signal disruption period is scheduled to start and end during the expected transmission of the first slot in the HS-DPCCH subframe.

In determination block 412, the wireless communication device processor may determine whether the calculated percentage is less than a threshold. If the percentage of transmission is less than the threshold, there is a high probability that the network will not be able to decode the uplink ACK/NACK data. Such a threshold also addresses a scenario in which an entire slot is wiped out due to a signal disruption (i.e., percentage of transmission is 0%), and the network has no chance of decoding the uplink ACK/NACK data. In some examples, the threshold may be a predetermined value established, for example, by a system operator associated with the first SIM, by the wireless communication device manufacturer, by the user, etc. In some examples, the threshold may be a percentage that is established or predetermined using parameters of the first network relating to network capabilities, preferences for tradeoffs between throughput and accuracy, etc. That is, the first network may establish as the threshold a minimum percentage of the uplink HARQ feedback that when received will result in the network being able to reliably decode the ACK/NACK data. In some examples, the minimum percentage may be communicated to the modem stack associated with the first SIM as a value of a new network parameter. In some examples, the modem stack associated with the first SIM may use existing network measurement parameters to determine the minimum percentage threshold. In some examples, the modern stack associated with the first SIM may be configured to use a default threshold value until a minimum percentage is obtained from the first network.

In response to determining that the calculated percentage is not less than the threshold (i.e., determination block 412=“No”), the wireless communication device processor may employ normal processes to handle the received HS-SCCH control signal on the modem stack associated with the first SIM in block 414. That is, the wireless communication device processor may assume that the network will be able to decode the uplink ACK/NACK data corresponding to the control signal received on the HS-SCCH, and initiate operations associated with the received HS-SCCH control signal (e.g., changing physical layer configurations, etc.). If the network transmits the HS-SCCH control signal and at that instant the wireless communication device determines that the slot carrying the corresponding uplink HARQ feedback can be fully transmitted, the corresponding operations associated with that order can be initiated.

In response to determining that the calculated percentage is less than the threshold value (i.e., determination block 412=“Yes”), the wireless communication device processor may ignore the received HS-SCCH control signal in block 416. That is, the wireless communication device processor may maintain current operations on the modem stack associated with the first SIM, such as by refraining from physical layer configuration changes, state transitions, etc. that may be associated with the received HS-SCCH instruction.

In block 418, the wireless communication device processor may schedule blank information for transmission in the first slot of the corresponding HS-DPCCH subframe. For example, the wireless communication device processor may generate a silence descriptor to transmit to the first network instead of the HARQ feedback. In some examples, the silence descriptor may be used in the same manner as in for discontinuous transmission (DTX), as specified in 3GPP Technical Specification (TS) 46.041 version 8.0.0 Release 8, entitled “Technical Specification 3rd Generation Partnership Project; Technical Specification Group Services and System Aspects; Half rate speech; Discontinuous Transmission (DTX) for half rate speech traffic channels” (December 2008).

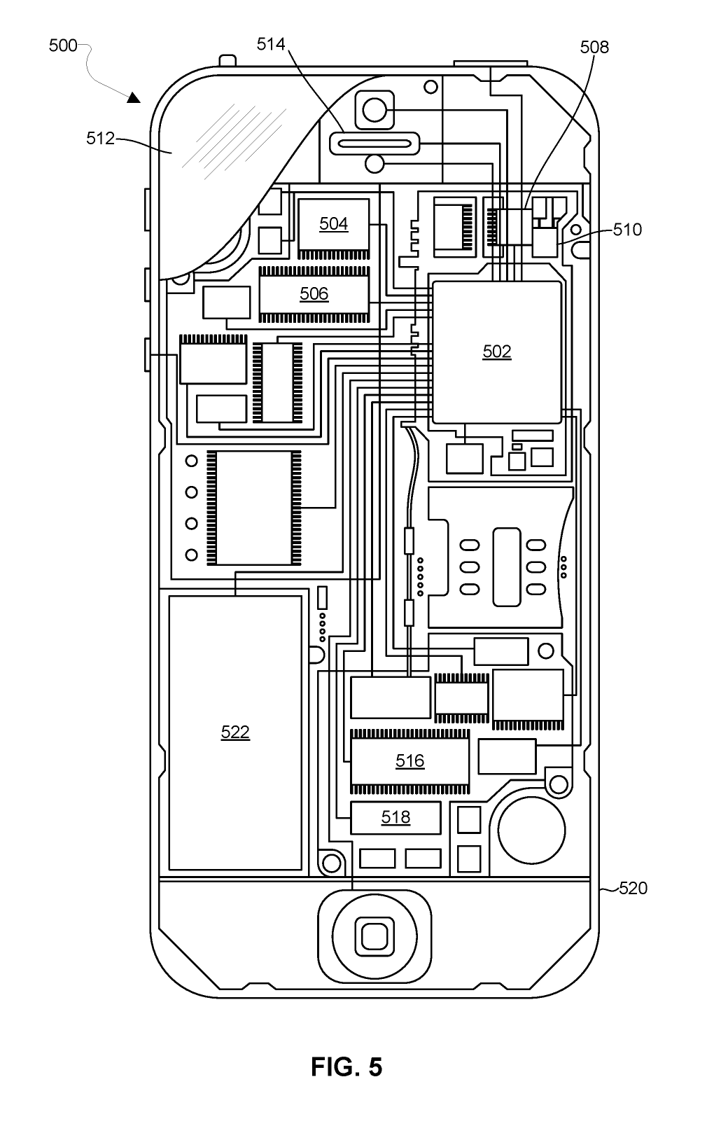

Various examples may be implemented in any of a variety of wireless communication devices, an example of which is illustrated in FIG. 5. For example, With reference to FIGS. 1-5, a wireless communication device 500 (which may correspond, for example, the wireless communication devices 102, 200 in FIGS. 1-2) may include a processor 502 coupled to a touchscreen controller 504 and an internal memory 506. The processor 502 may be one or more multicore integrated circuits (ICs) designated for general or specific processing tasks. The internal memory 506 may be volatile or non-volatile memory, and may also be secure and/or encrypted memory, or unsecure and/or unencrypted memory, or any combination thereof.

The touchscreen controller 504 and the processor 502 may also be coupled to a touchscreen panel 512, such as a resistive-sensing touchscreen, capacitive-sensing touchscreen, infrared sensing touchscreen, etc. The wireless communication device 500 may have one or more radio signal transceivers 508 (e.g., Peanut®, Bluetooth®, Zigbee®, Wi-Fi, RF radio) and antennae 510, for sending and receiving, coupled to each other and/or to the processor 502. The transceivers 508 and antennae 510 may be used with the above-mentioned circuitry to implement the various wireless transmission protocol stacks and interfaces. The wireless communication device 500 may include a cellular network wireless modem chip 516 that enables communication via a cellular network and is coupled to the processor. The wireless communication device 500 may include a peripheral device connection interface 518 coupled to the processor 502. The peripheral device connection interface 518 may be singularly configured to accept one type of connection, or multiply configured to accept various types of physical and communication connections, common or proprietary, such as USB, FireWire, Thunderbolt, or PCIe. The peripheral device connection interface 518 may also be coupled to a similarly configured peripheral device connection port (not shown). The wireless communication device 500 may also include speakers 514 for providing audio outputs. The wireless communication device 500 may also include a housing 520, constructed of a plastic, metal, or a combination of materials, for containing all or some of the components discussed herein. The wireless communication device 500 may include a power source 522 coupled to the processor 502, such as a disposable or rechargeable battery. The rechargeable battery may also be coupled to the peripheral device connection port to receive a charging current from a source external to the wireless communication device 500.

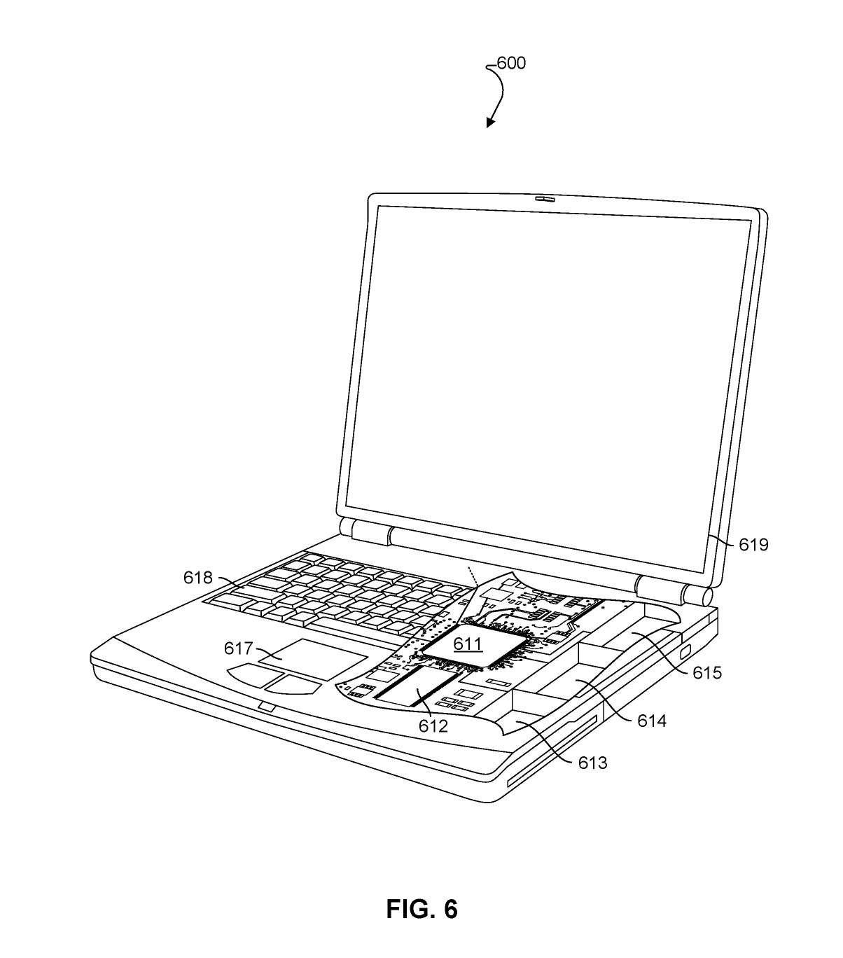

With reference to FIGS. 1-6, various examples described herein may also be implemented within a variety of personal computing devices, such as a laptop computer 600 (which may correspond, for example, the wireless communication devices 102, 200) as illustrated in FIG. 6. Many laptop computers include a touchpad touch surface 617 that serves as the computer's pointing device, and thus may receive drag, scroll, and flick gestures similar to those implemented on wireless computing devices equipped with a touch screen display and described above. The laptop computer 600 will typically include a processor 611 coupled to volatile memory 612 and a large capacity nonvolatile memory, such as a disk drive 613 of Flash memory. The laptop computer 600 may also include a floppy disc drive 614 and a compact disc (CD) drive 615 coupled to the processor 611. The laptop computer 600 may also include a number of connector ports coupled to the processor 611 for establishing data connections or receiving external memory devices, such as a Universal Serial Bus (USB) or FireWire® connector sockets, or other network connection circuits for coupling the processor 611 to a network. In a notebook configuration, the computer housing includes the touchpad touch surface 617, the keyboard 618, and the display 619 all coupled to the processor 611. Other configurations of the computing device may include a computer mouse or trackball coupled to the processor (e.g., via a USB input) as are well known, which may also be used in conjunction with various examples.

The processors 502 and 611 may be any programmable microprocessor, microcomputer or multiple processor chip or chips that can be configured by software instructions (applications) to perform a variety of functions, including the functions of various examples described above. In some devices, multiple processors may be provided, such as one processor dedicated to wireless communication functions and one processor dedicated to running other applications. Typically, software applications may be stored in the internal memory 506, 612 and 613 before they are accessed and loaded into the processors 502 and 611. The processors 502 and 611 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 502, 611, including internal memory or removable memory plugged into the device and memory within the processor 502 and 611, themselves.

The foregoing method descriptions and the process flow diagrams are provided merely as illustrative examples and are not intended to require or imply that the steps of various examples must be performed in the order presented. As will be appreciated by one of skill in the art the order of steps in the foregoing examples may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a SIM and data receiving associated with a different SIM, such identifiers are merely for convenience and are not meant to limit the various examples to a particular order, sequence, or carrier.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The various illustrative logical blocks, circuits, and algorithm steps described in connection with the examples disclosed herein may be implemented as electronic hardware, computer software, or combinations of both. To clearly illustrate this interchangeability of hardware and software, various illustrative components, blocks, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more examples, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed examples is provided to enable any person skilled in the art to make or use the claims. Various modifications to these examples will be readily apparent to those skilled in the art, and the generic principles defined herein may be applied to other implementations without departing from the scope of the claims. Thus, the claims are not intended to be limited to the examples shown herein but are to be accorded the widest scope consistent with the following claims and the principles and novel features disclosed herein.

What is claimed is:

1. A method of improving performance of a wireless communication device, comprising:
detecting an active communication with a first network on a modem stack associated with a first subscriber identity module (SIM);
detecting when a control signal is received on the modem stack associated with the first SIM;
identifying a percentage of scheduled uplink feedback corresponding to the control signal received on the modem stack associated with the first SIM that will be transmitted on the first network (“identified percentage”);
determining whether the identified percentage is less than a threshold; and
ignoring operations instructed by the control signal received on the modem stack associated with the first SIM in response to determining that the percentage of scheduled uplink feedback that will be transmitted on the first network is less than the threshold.

2. The method of claim 1, wherein identifying the percentage of scheduled uplink feedback that will be transmitted on the first network comprises calculating an amount of overlap between a slot scheduled to carry physical layer acknowledgment/non-acknowledgment (ACK/NACK) data and an upcoming signal disruption period.

3. The method of claim 2, wherein the threshold is based on a configuration associated with the first network.

4. The method of claim 2, wherein calculating the amount of overlap comprises:
using offsets between subframes on physical channels to identify a transmission time interval (TTI) for uplink feedback corresponding to the control signal received on the modem stack associated with the first SIM; and
identifying scheduled timing for an upcoming signal disruption period.

5. The method of claim 1, wherein ignoring an instruction of the control signal received on the modem stack associated with the first SIM comprises:
maintaining a current physical layer configuration on the modem stack associated with the first SIM; and
replacing scheduled uplink feedback with blank data using a silence descriptor frame.

6. The method of claim 1, wherein the control signal received on the modem stack associated with the first SIM comprises an instruction to transition to a dual carrier mode for high speed downlink packet access (HSDPA) or high speed uplink packet access (HSUPA) communications by enabling a secondary carrier.

7. The method of claim 1, wherein the control signal received on the modem stack associated with the first SIM comprises an instruction to transition to a single carrier mode for high speed downlink packet access (HSDPA) or high speed uplink packet access (HSUPA) communications by disabling a secondary carrier.

8. The method of claim 1, wherein the control signal received on the modem stack associated with the first SIM comprises one or more instructions carried on a high speed signaling control channel (HS-SCCH).

9. The method of claim 1, wherein the control signal received on the modem stack associated with the first SIM comprises an instruction to activate or deactivate one or more Continuous Packet Connectivity (CPC) features.

10. The method of claim 2, wherein the ACK/NACK data is used in a hybrid automatic repeat request (HARQ) protocol, and wherein the ACK/NACK data indicates whether the control signal received on the modem stack associated with the first SIM was successfully decoded.

11. The method of claim 2, wherein the slot scheduled to carry the ACK/NACK data corresponding to the control signal received on the modem stack associated with the first SIM comprises a first slot of a high speed dedicated physical control channel (HS-DPCCH) subframe, wherein a start of the HS-DPCCH subframe is aligned to provide 7.5 slots of processing time from an end of a high speed physical downlink shared channel (HS-PDSCH) subframe carrying downlink data.

12. The method of claim 1, wherein ignoring operations instructed by the control signal received on the modem stack associated with the first SIM comprises:
replacing scheduled uplink feedback corresponding to the control signal received on the modem stack associated with the first SIM with blank data using a silence descriptor frame.

13. The method of claim 1, further comprising detecting an upcoming signal disruption period during the active communication in the first network by detecting a scheduled tune-away by a shared radio frequency (RF) resource from the first network to a second network associated with a second SIM, wherein the shared RF resource tunes back to the first network after the tune-away.

14. The method of claim 1, further comprising detecting an upcoming signal disruption period during the active communication in the first network by detecting a temporary deep fade on a channel associated with connecting to the first network.

15. The method of claim 1, further comprising detecting an upcoming signal disruption period during the active communication in the first network by detecting a gap in the active communication to perform neighbor cell measurements.

16. The method of claim 1, wherein the first network supports at least high speed downlink packet access (HSDPA).

17. A wireless communication device, comprising:
a radio frequency (RF) resource; and
a processor coupled to the RF resource, configured to connect to at least a first subscriber identity module (SIM), and configured with processor-executable instructions to:
detect an active communication with a first network on a modem stack associated with the first SIM;
detect when a control signal is received on the modem stack associated with the first SIM;
identify a percentage of scheduled uplink feedback corresponding to the control signal received on the modem stack associated with the first SIM that will be transmitted on the first network (“identified percentage”);
determine whether the identified percentage is less than a threshold; and
ignore operations instructed by the control signal received on the modem stack associated with the first SIM in response to determining that the percentage of scheduled uplink feedback that will be transmitted on the first network is less than the threshold.

18. The wireless communication device of claim 17, wherein the processor is further configured with processor-executable instructions to identify the percentage of scheduled uplink feedback that will be transmitted on the first network by calculating an amount of overlap between a slot scheduled to carry physical layer acknowledgment/non-acknowledgment (ACK/NACK) data and an upcoming signal disruption period.

19. The wireless communication device of claim 18, wherein the processor is further configured with processor-executable instructions to calculate the amount of overlap by:
using offsets between subframes on physical channels to identify a transmission time interval (TTI) for uplink feedback corresponding to the control signal received on the modem stack associated with the first SIM; and
identifying scheduled timing for an upcoming signal disruption period.

20. The wireless communication device of claim 17, wherein the processor is further configured with processor-executable instructions to ignore an instruction of the control signal received on the modem stack associated with the first SIM by:
maintaining a current physical layer configuration on the modem stack associated with the first SIM; and
replacing scheduled uplink feedback with blank data using a silence descriptor frame.

21. The wireless communication device of claim 17, wherein the control signal received on the modem stack associated with the first SIM comprises an instruction to transition to a dual carrier mode for high speed downlink packet access (HSDPA) or high speed uplink packet access (HSUPA) communications by enabling a secondary carrier.

22. The wireless communication device of claim 17, wherein the control signal received on the modem stack associated with the first SIM comprises one or more instructions carried on a high speed signaling control channel (HS-SCCH).

23. The wireless communication device of claim 17, wherein the control signal received on the modem stack associated with the first SIM comprises an instruction to activate or deactivate one or more Continuous Packet Connectivity (CPC) feature.

24. The wireless communication device of claim 18, wherein the ACK/NACK data is used in a hybrid automatic repeat request (HARQ) protocol, and wherein the ACK/NACK data indicates whether the control signal received on the modem stack associated with the first SIM was successfully decoded.

25. The wireless communication device of claim 17, wherein the processor is further configured with processor-executable instructions to ignore operations instructed by the control signal received on the modem stack associated with the first SIM by:
replacing scheduled uplink feedback corresponding to the control signal received on the modem stack associated with the first SIM with blank data using a silence descriptor frame.

26. The wireless communication device of claim 17, wherein the processor is further configured with processor-executable instructions to:
detect an upcoming signal disruption period during the active communication in the first network by detecting a scheduled tune-away by the RF resource from the first network to a second network associated with a second SIM, wherein the RF resource tunes back to the first network after the tune-away.

27. The wireless communication device of claim 17, wherein the processor is further configured with processor-executable instructions to detect an upcoming signal disruption period during the active communication in the first network by detecting a temporary deep fade on a channel associated with connecting to the first network.

28. The wireless communication device of claim 17, wherein the processor is further configured with processor-executable instructions to detect an upcoming signal disruption period during the active communication in the first network by detecting a gap in the active communication to perform neighbor cell measurements.

29. A wireless communication device, comprising:
a radio frequency (RF) resource;
means for detecting an active communication with a first network on a modem stack associated with a first subscriber identity module (SIM);
means for detecting when a control signal is received on the modem stack associated with the first SIM;
means for identifying a percentage of scheduled uplink feedback corresponding to the control signal received on the modem stack associated with the first SIM that will be transmitted on the first network (“identified percentage”);
means for determining whether the identified percentage is less than a threshold; and
means for ignoring operations instructed by the control signal received on the modem stack associated with the first SIM in response to determining that the percentage of scheduled uplink feedback that will be transmitted on the first network is less than the threshold.

30. A non-transitory processor-readable storage medium having stored thereon processor-executable instructions configured to cause a processor of a wireless communication device having a radio frequency (RF) resource configured to connect to at least a first subscriber identity module (SIM) to perform operations comprising:
detecting an active communication with a first network on a modem stack associated with the first SIM;
detecting that a control signal was received on the modem stack associated with the first SIM;
identifying a percentage of scheduled uplink feedback corresponding to the control signal received on the modem stack associated with the first SIM that will be transmitted on the first network (“identified percentage”);
determining whether the identified percentage is less than a threshold; and
ignoring operations instructed by the control signal received on the modem stack associated with the first SIM in response to determining that the percentage of scheduled uplink feedback that will be transmitted on the first network is less than the threshold.
